(19) United States
(12) Patent Application Publication
(10) Pub. No.: US 2019/0304040 A1
(43) Pub. Date: Oct. 3, 2019

(54) System and Method for Vetting Potential Jurors

(71) Applicant: Bryce Gartner, Holly Springs, NC (US)

(72) Inventor: Bryce Gartner, Holly Springs, NC (US)

(21) Appl. No.: 15/938,428

(22) Filed: Mar. 28, 2018

(51) Int. Cl. G06Q 50/18; G06F 17/30

(52) U.S. Cl. CPC G06Q 50/18; G06F 17/30964

(57) ABSTRACT

This document presents a system and method for vetting potential jurors. The system comprises a database, an analysis engine, and a user interface. The database stores information regarding participants in a trial and a panel of potential jurors for the trial. The database also stores lists of network destinations that may hold public records and social media postings related to the potential jurors and the participants. The analysis engine may collect information from the network destinations and add it to the database. The analysis engine may score and rank potential jurors. The method described disclosure the steps involved in collecting the information and calculating scores and rankings. The invention may also highlight significant findings such as familial, social, business, or membership connections that exist between potential jurors and participants.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

The present invention pertains to the field of litigation tools. More specifically, the present invention pertains to a system and method for vetting potential jurors.

The process of selecting a jury, commonly referred to as voir dire, involves determining whether any potential jury is biased or unable to make a fair decision for any reason. There may be many different sources of bias. As non-limiting examples, a potential jury may be biased due to racial or ethnic differences, for religious reasons, due to personal connections to any person or entity involve in the litigation, for reasons related to the occupation of the potential juror and/or the litigants, for reasons related to their upbringing, or for a whole host of other reasons too numerous to list. It is a common practice for the court systems to have potential jurors complete a juror questionnaire that reveals some demographic factors and it is a common for the court systems to allow attorneys representing each side in a trial to question potential jurors to try to reveal more about the potential juror's biases and attitudes.

The voir dire process permits attorneys to disqualify or request removal of potential jurors because of discovered bias. Disqualifying jurors can have the effect of shifting the composition of a jury so as to be perceived as being more favorable to either the defense or the prosecution. For this reason, the process of mounting challenges to successfully remove one or more jurors is a serious undertaking for both the prosecution and defense attorneys. Mounting a challenge is necessarily an information intensive undertaking, and the more recent and thorough the information about each potential juror, the better positioned each attorney is to form decisions and make challenges to jurors during voir dire.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a block diagram of a system consistent with certain embodiments of the present invention.

FIG. 2 is a flow diagram of a methodology applied prior to a voir dire proceeding consistent with certain embodiments of the present invention.

FIG. 3 is a flow diagram of a methodology applied during a voir dire proceeding consistent with certain embodiments of the present invention.

FIG. 4 is a block diagram illustrating a portion of a scoring process consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

### (Definitions)

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component may include a program, a sub-routine, a portion of a program, a software component, or a hardware component that may perform one or more stated tasks or functions. As used herein, a module or component can exist on a hardware component independently of other modules or components. Alternatively, a module or component can be a shared element or process of other modules, programs or machines.

Some embodiments described herein can generally require the use of the computing devices, including processing and memory resources.

As a non-limiting example, one or more embodiments described herein may be implemented, in whole or in part, on the computing devices. Non-limiting examples of the computing devices may include servers, desktop computers, cellular or smartphones, laptop computers, and tablet devices.

Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium.

Machines shown or described within figures associated with this disclosure may provide non-limiting examples of processing resources and computer-readable media on which instructions for implementing embodiments described herein can be carried and/or executed. In particular, the numerous machines shown with non-limiting examples described herein include processor(s) and memory for holding data and instructions.

Non-limiting examples of computer-readable mediums include permanent memory storage devices, such as hard drives utilizing rotating media or Solid State Drives. Other non-limiting examples of computer storage media include portable storage units, such as CD or DVD units, flash memory, USB storage devices, and magnetic memory. Computers, terminals, sensors, mobile devices, and network enabled devices are all non-limiting examples of machines and devices that utilize processors, memory, and instructions stored on computer-readable mediums.

Additionally, embodiments may be implemented in the form of computer-programs, or a computer usable carrier medium that carries such a program.

Data lists of jurors, juror questionnaires, litigants, witnesses, court officials, plaintiffs, and/or defendants may be provided to a trial team utilizing the disclosed system in advance of jury selection. The trial team may be either a prosecuting trial team, or a defense trial team, or both. In a non-limiting example, the list of litigants may be provided by the court clerk to the user of the invention. The list of litigants may be in the form of one or more printed documents or it may be provided as machine-readable information. As non-limiting examples, the list of litigants may be provided on a USB key, as an email attachment, or as one or more downloadable network files in PDF, XML, text, spreadsheet, or other industry standard format. Data entry of the list of litigants into the juror information database may be done by the user via the user interface in communication with the analysis engine and may involve manually typing entries into the user interface or may involve importing the list of litigants into the user interface from one or more machine-readable files. The analysis engine may create or update one or more database records based upon the content of the one or more lists provided to the system.

The entry of the list of potential juror names into the juror information database may result in the creation of the juror information record for each individual juror name on the list of potential juror names. In a non-limiting embodiment, each juror information record may be maintained in a database associated with the computing system upon which the analysis engine is in operation, or may be maintained in a database associated with any computing system, such as a database server, that maintains a networked connection with the computing system on which the analysis engine is operating.

The system and method for vetting potential jurors provides systems for assisting a trial team in improving the results of the jury selection process, also known as voir dire. Embodiments of the system store data, analyze the data, allow the data and analysis parameters to be modified, and present the analysis results. The system utilizes juror specific responses and publicly available information to provide rankings of a plurality of potential jurors based upon criteria defined by an attorney and the trial team. The invention further comprises a method for collecting the information, analyzing the information, and presenting rankings of potential jurors. At least a portion of the analysis may be performed in real time, during the jury empanelment proceeding with updated information presented to the interested attorney during the actual voir dire proceeding.

The system may comprise a database server, an analysis engine, and a user interface. The database server may comprise software running on a first computing device. The database server may store a juror information database that holds a plurality of data records pertaining to a trial. The analysis engine may comprise software modules implementing a methodology that will be described later herein. The analysis engine may be running on the first computing device or on a second computing device. The user interface may be composed of presentation software running on the first computing device, on the second computing device, or on a third computing device. The user interface may comprise software which communicates with the analysis engine, presents status of the analysis engine, presents data stored in the database server for viewing, and accepts input and communicates it to the analysis engine. The user interface may further present the results of analysis performed by the analysis engine. As non-limiting examples, the user interface may present juror final scores, juror indexes, juror rankings, and one or more messages produced by the analysis engine. In some embodiments, the user interface may be a web browser.

As non-limiting examples, the plurality of data records stored in the database server may comprise juror information records, a list of public records network destinations, a list of social media network destinations, a list of panel questions, demographic parameters, social media parameters, panel response parameters, weighted demographic component scores, weighted social media component scores, weighted panel analysis component scores, the juror final scores, the juror indexes, the juror rankings, panel question responses, trial specific information, or combinations thereof. As non-limiting examples, the first computing device, the second computing device, and the third computing device may each be a server, a desktop computer, a laptop computer, a tablet, a smartphone, or any other network connected device having a processor and associated memory.

Communications between the database server, the analysis engine, and the user interface may be via messages passed on a network or via interprocess communication if they are co-resident on the computing device.

A list of potential juror names may be provided to the trial team in advance of jury selection. In a non-limiting example, the list of potential juror names may be provided by a court clerk to a user of the invention; the user being a member of the trial team. The list of potential juror names may be in the form of one or more printed documents or it may be provided as machine-readable information as described above. The analysis engine may create or update one or more database records based upon the content of the list of potential juror names.

A plurality of juror questionnaires may be provided to any trial team in advance of jury selection. In a non-limiting example, the plurality of juror questionnaires may be provided by the court clerk to the user of the system herein disclosed. The plurality of juror questionnaires may be in the form of one or more printed documents or it may be provided as machine-readable information as described above.

The plurality of juror questionnaires may comprise juror demographic information and other information pertaining to the potential juror. As non-limiting examples, an individual juror questionnaire may provide the following information for the potential juror and their spouse (if any): first, last and middle name, age, gender, occupation, employer, education level, annual income, marital status, number of children, phone number, email address, and home address. The information obtained from the plurality of juror questionnaires may be used to update the juror information records. Each of the juror information records may identify the individual juror questionnaire as the source of the juror demographic information.

The juror demographic information obtained from the individual juror questionnaire may be used for a number of purposes. The juror demographic information may hint at a viewpoint or biases that the potential juror may have given the specific circumstances of the trial. Such bias may in turn be utilized to create a challenge for dismissing a particular juror. In a non-limiting example, if the trial involves a misconduct charge filed against a law enforcement office, the potential juror may be expected to be sympathetic to the defendant if the potential juror works in law enforcement.

The juror demographic information may also be used to correlate information found at public records network destinations and social media network destinations. In a non-limiting example, if the potential juror is a white, 47-year old male named Pat Wilson, information found at a website regarding a 25-year old, African American woman named Pat Wilson is probably not relevant.

The list of litigants may be a record of all individuals and/or entities involved in the trial as litigants, identified as either plaintiffs or defendants. The list of litigants may be used during the determination of connections between the potential juror and parties on either side of the litigation. The list of litigants may contain demographic information or contact information regarding litigants and this information may be entered into the juror information database and is associated with the individual litigants. The list of litigants may be stored in the juror information database as the trial specific information.

A list of witnesses may be provided to the trial team in advance of jury selection. As a non-limiting example, the list of witnesses may be provided by the court clerk to the user of the invention. The list of witnesses may be in the form of one or more printed documents or it may be provided as machine-readable information as described above. The analysis engine may create or update one or more database records based upon the content of the list of witnesses.

The list of witnesses may be a record of all individuals who have been identified as potential witnesses during the trial. Each individual on the list of witnesses may be identified as a witness for the prosecution or as a witness for the defense and this information is entered into the database. The list of witnesses may be used during the determination of connections between the potential juror and witnesses. The list of witnesses may contain demographic information or contact information regarding witnesses and this information may be entered into the juror information database and is associated with the individual witnesses. The list of witnesses may be stored in the juror information database as the trial specific information.

A list of court officials may be provided to the trial team in advance of jury selection. As a non-limiting example, the list of court officials may be provided by the court clerk to the user of the invention. The list of court officials may be in the form of one or more printed documents or it may be provided as machine-readable information as described above. The analysis engine may create or update one or more database records based upon the content of the list of court officials.

The list of court officials may be a record of all individuals who are not litigants or witnesses but who have been identified as playing a role during the trial. As non-limiting examples, court officials may include judges, attorneys, coroners, medical examiners, bailiffs, court reporters, law clerks, court-appointed special advocates, and paralegals. The list of court officials may be used during the determination of connections between the potential juror and court officials. The list of court officials may contain demographic information or contact information regarding court officials and this information may be entered into the juror information database and is associated with the individual court officials. The list of court officials may be stored in the juror information database as the trial specific information.

The trial team may create the list of public records network destinations. The list of public records network destinations may be stored within the juror information database. The list of public records network destinations may be reused at multiple trials, possibly with additions, deletions, and modifications for each trial.

The list of public records network destinations may comprise metadata regarding each network destination that appears on the list of public records network destinations. Each network destination may comprise a source of information that is available for consumption by the public. The metadata may provide details that the analysis engine may be able to use to interrogate each network destination on the list of public records network destinations. As non-limiting examples, the metadata may provide, for each network destination, a name for the network destination, a network address, and structured information regarding how to form queries directed to the network destination in order to obtain specific pieces of information.

Information obtained from the public records network destinations listed in the list of public records network destinations may be used to supplement the juror demographic information that is stored within the juror information record. Specifically, if the potential juror can be found at the public records network destinations using the juror demographic information already known in the juror information record, then additional information regarding the potential juror may be acquired from the network destination. As non-limiting examples, the analysis engine may use information obtained from network destinations appearing on the list of public records network destinations to determine the religious preference of the potential juror, their political party affiliation, charitable donation history, whether or not the potential juror is a home owner and, if so, the value of their property.

The trial team may create the list of social media network destinations. The list of social media network destinations may be stored within the juror information database. The list of social media network destinations may be reused at multiple trials, possibly with additions, deletions, and modifications for each trial.

The list of social media network destinations may comprise metadata regarding each network destination that appears on the list of social media network destinations. Each network destination may comprise a source of information that may contain social media content associated with an individual. The metadata may provide details that the analysis engine may be able to use to interrogate each network destination on the list of public records network destinations. As non-limiting examples, the metadata may provide, for each network destination, a name for the network destination, a network address, and structured information regarding how to form queries directed to the network destination in order to obtain specific pieces of information. As non-limiting examples, the analysis engine may use information obtained from network destinations appearing on the list of social media network destinations to determine specific viewpoints expressed by the potential juror, such as whether they are pro-law enforcement, anti-immigrant, pro-gun control, or anti-death penalty.

The trial team may create the list of panel questions. The list of panel questions may be stored within the juror information database. The list of panel questions may be reused at multiple trials, possibly with additions, deletions, and modifications for each trial. The list of panel questions may be recalled from the juror information database during the voir dire process and presented to the attorney and/or to the trial team via the user interface. Alternatively, the list of panel questions or a subset thereof may be printed from the juror information database. Specific questions from the list of panel questions may be selected for asking during voir dire.

The list of panel questions may be divided into one or more categories. As non-limiting examples, any questions that may bring to light a racial bias may be in a first category, questions that may bring to light anti-corporate sentiments may be in a second category, and questions intended to highlight contempt for medical institutions may be in a third category. In some embodiments, a single question may be assigned to more than one category.

Unless stated otherwise, any of the lists described in this disclosure may be modified at any point during the preparation and prosecution of a trial. Alteration of a list may require that the analysis engine be invoked to score and rank the plurality of potential jurors with regard to the data associated with the list alteration to update the score and juror rank to assure accurate results.

The trial team may define the demographic parameters. The demographic parameters may be stored within the juror information database. The demographic parameters may be reused at multiple trials, possibly with additions, deletions, and modifications for each trial. The demographic parameters may allow the attorney and the trial team to specify which pieces of information that the analysis engine will request from network destinations that appear on the list of public records network destinations.

The demographic parameters may allow the attorney and the trial team to specify how the analysis engine will interpret the information. The demographic parameters may specify a value or range of values for each parameter and may associate a demographic parameter score with an actual record matching that value or lying within that range of values. The demographic parameters may comprise a plurality of such values or ranges of values.

The demographic parameters may include a demographic weighting factor. The demographic weighting factor may allow the relative importance, as expressed by the weighting factor, of a particular piece of information to be increased or decreased relative to other pieces of information that are included as demographic parameters. The demographic weighting factor may include a plurality of demographic parameters. In general, a demographic weighting factor will be defined for each value or range of values that are defined for each demographic parameter.

In a non-limiting example, the demographic parameters may include a parameter called HOMEOWNER that the analysis engine should interpret by assigning a score of 0 if the demographic information indicates that the potential juror is not a homeowner or a score of 100 if the potential juror is a homeowner. The demographic parameters may further weight the HOMEOWNER parameter as 10 on a scale of 0 to 100, meaning that for this current trial, being a homeowner has a minor relevance.

The trial team may define the social media parameters. The social media parameters may be stored within the juror information database. The social media parameters may be reused at multiple trials, possibly with additions, deletions, and modifications for each trial. The social media parameters may allow the attorney and the trial team to specify which pieces of information that the analysis engine will request from network destinations that appear on the list of social media network destinations.

The social media parameters may allow the attorney and the trial team to specify how the analysis engine will interpret the information. The social media parameters may specify a value or range of values for each parameter and may associate a social media parameter score with an actual record matching that value or lying within that range of values. The social media parameters may comprise a plurality of such values or ranges of values.

The social media parameters may comprise social media weighting factor. The social media weighting factor may allow the relative importance of a particular piece of information to be increased or decreased relative to other pieces of information that are social media information. The social media weighting factor may be composed of a plurality of social media parameters and/or data. In general, one social media weighting factor will be defined for each value or range of values that are defined within the social media parameters.

As a non-limiting example, one of the social media parameters may be defined as a parameter called POSTING_ACTIVITY that the analysis engine should interpret by assigning a value of 100 if the potential juror is not active on social media or a value from 1 to 99 based upon the frequency of social media postings, with higher frequency of postings resulting in the lowest scores. This weighting would indicate that extreme levels of social media posting is viewed as an undesirable characteristic for the potential juror in this trial. The system may further weight the POSTING_ACTIVITY parameter as 85 on a scale of 0 to 100, meaning that for this current trial, being active on social media is very relevant.

The trial team may define the panel response parameters. The panel response parameters may be stored within the juror information database. The panel response parameters may be reused at multiple trials, possibly with additions, deletions, and modifications for each trial. The panel response parameters may allow the attorney and the trial team to specify how the analysis engine will interpret the responses that the potential juror gives during voir dire panel questioning. The panel response parameters may also include a panel analysis category weighting factor. The panel analysis category weighting factor may allow the relative importance of a particular question category to be increased or decreased relative to other question categories.

In general, a panel question score will be recalculated and a newly updated resulting score determined by a member of the trial team in the courtroom after each of the potential jurors answers each question. The panel question score may be entered using a 5 point scale of very unfavorable, unfavorable, neutral, favorable, very favorable. The analysis engine may normalize the panel question scores from the 5-pt scale to a scale of 0 to 100.

Some questions may be directed to more than one of the potential jurors. In a non-limiting example, the question may be “show of hands—how many of you have ever had a surgical procedure performed on you”? It is possible that in response to such a question, multiple members of the trial team may be assigned to note the responses of specific grouping(s) of the potential jurors so that all responses may be captured. The panel question scores will be entered into the user interface for each of the potential jurors who responded and the panel question scores will be sent to the analysis engine. The analysis engine may then average the received panel question scores with existing panel question scores in the same category that were previously captured. A panel analysis category score may then be stored back in the juror information database after a new average has been computed. An average score is used within each category instead of the individual questions scores because of the possibility that different members of the trial team may be scoring questions. Using a category average may help mitigate scoring differences between members of the trial team.

In some embodiments, the panel response parameters may allow the attorney and the trial team to suggest responses that may be given for each question in the list of panel questions. The attorney or trial team may suggest a value or range of values for each parameter and may associate the panel analysis category score with a response matching that value or lying within that range of values.

As a non-limiting example, the list of panel questions may define a question regarding number of surgical procedures and may assign the question to a category called MEDICAL_HISTORY. The panel response parameters may further suggest a scoring for the question which is to give a score of 100 for no previous surgical procedures, a score of 50 for having 1 previous surgical procedure, and a score of 0 for 2 or more previous surgical procedures. The panel response parameters may further weight the MEDICAL_HISTORY category as 100 on a scale of 0 to 100, meaning that for this current trial, prior surgical experience is very relevant. In this example, additional questions defined in the list of panel questions and assigned to the category MEDICAL_HISTORY may deal with the types of surgeries, the surgical outcomes, number of prescription medications used daily, and other medical history facts.

In an embodiment, the act of entering the panel question scores into the user interface as the questions are answered causes the analysis engine to store the response within the panel question responses, to re-compute final scores and rankings, and to present the recomputed final scores and rankings to the user or users. The final scores and rankings are therefore updated in real time and are always accurate based upon the questions previously asked and answered at any point in time during the voir dire process.

The public records network destinations may be network addressable computers where an entity may post information and collections of information of interest to the general public. As non-limiting examples, the entities may be government agencies, corporations, or media outlets. Non-limiting examples of the information that may be posted include tax records, real estate transactions, arrest records, news stories, birth records, registered voter records, death records, marriage records, court calendars, membership rosters, contact information, lists of previous residences, and other public records. Communication with the public records website may utilize HTTP, HTTPS, FTP, or other network protocols.

The social media network destinations may be network addressable computers where a plurality of users post information of a social nature. Non-limiting examples of the information that may be posted include announcements, comments, replies to previous posts, social calendars, news stories, opinions, photographs, videos, music, advertisements, and other multi-media content.

The list of public records network destinations and the list of social media network destinations may inform the analysis engine of the network address to use in reaching the public records network destinations and the social media network destinations. The list of public records network destinations and the list of social media network destinations may additionally inform the analysis engine of the specific content to request, how to request it, and how to interpret the returned results. In a non-limiting example, the list of social media network destinations may inform the analysis engine of a URL representing a specific social media website and the URL provided may have parameters to invoke a search for a specific individual, once the parameters have been filled in using known demographics of the potential juror. In response to the URL requested by the analysis engine, the social media website may return HTML, XML, a text file, a spreadsheet, or another machine-readable response. The list of social media network destinations may inform the analysis engine that to interpret the response, a particular sequence of XML tags or HTML tags must be parsed, a particular entry in a spreadsheet must be found and the response value will be at a particular column in the same row, or that a textual keyword search must be performed to find the response value.

In some embodiments, the analysis engine may use a consistent scoring protocol that defines scores on a scale of 0 to 100, with higher scores being considered desirable or positive and lower scores being considered undesirable or negative. Although this scoring protocol should not be considered limiting as any scoring protocol that maintains consistency across all calculated scores and provides clear guidance to the user or users may be equally defined and used by the analysis engine.

In some embodiments, the analysis engine may use consistent weighting values from 0 to 100, with 0 meaning that a parameter has no significance to the current trial and 100 meaning that the parameter is of paramount importance to the current trial. The weight may be treated as a percentage and therefore the weights of all weighted parameters used to score a component must total 100.

In an embodiment, there may be dozens or even hundreds of parameters and/or categories covering the demographics component, the social media component, and the panel question component of the scoring and ranking preformed by the analysis engine. In a non-limiting example, a weight of 0 associated with any individual parameter and/or category may indicate a parameter that is not included in the analysis for the current trial.

In an embodiment, the analysis engine may score the demographic component by calculating a demographic component score. The demographic component score may be calculated by multiplying the demographic parameter score by the demographic weighting factor for each parameter to compute a weighted demographic parameter score for each parameter. The weighted demographic parameter scores for each parameter may then be summed to compute the demographic component score.

As a non-limiting example, five of the demographic parameters (A, B, C, D, and E) are of interest to the trial team. The trial team assigns weights Aw=50, Bw=10, Cw=20, Dw=15, and Ew=5. The five parameters score values of As=80, Bs=70, Cs=50, Ds=100, and Es=40. Note first that the weights total 100. The weighted demographic scores associated with the five parameters will be Aws=40, Bws=7, Cws=10, Dws=15, and Ews=2, calculated as 80×0.50, 70×0.10, 50×0.20, 100×0.15, and 40×0.05. The demographic component score for these values will be 74 when calculated as the sum of the weighted demographic scores.

The analysis engine may score the social media component by calculating a social media component score. The social media component score may be calculated by multiplying the social media parameter score by the social media weighting factor for each parameter to compute a weighted social media parameter score for each parameter. The weighted social media parameter scores for each parameter may then be summed to compute the social media component score.

The analysis engine may score the panel analysis component by calculating a panel analysis component score. The panel analysis component score may be calculated by multiplying the panel analysis category score by the panel analysis category weighting factor for each parameter to compute a weighted panel analysis score for each category. The weighted panel analysis scores for each category may then be summed to compute the panel analysis component score. In an embodiment, the panel analysis category scores are category scores representing the average response for one or more questions in the same category and that the panel analysis category weighting factors are weighting factors for the categories and not for individual questions.

In a preferred embodiment, the analysis engine may calculate the juror final scores. A juror final score may be calculated for each of the potential jurors. Each of the juror final scores may combine the scores for the demographic component, social media component, and panel analysis component into one score for the potential juror. The juror final scores may also comprise a demographic component weight, a social media component weight, and a panel analysis component weight which allows the trial team to designate which components are more critical for the current trial. The juror final scores may be computed by summing the products of the multiplication of the demographic component score by the demographic component weight, the multiplication of the social media component score by the social media component weight, and the multiplication of the panel analysis component score by the panel analysis component weight for each of the potential jurors.

In an embodiment, the analysis engine may calculate the juror indexes. A juror index may be calculated for each of the potential jurors. The juror indexes may be computed by first computing an average juror score by summing the juror final scores and dividing that sum by the count of the potential jurors. The juror final score for a specific one of the potential jurors may then be divided by the average juror score to determine the juror index for the potential juror. The calculation as described results in a score of 1.0 for an average juror, a score above 1.0 for a more favorable match to the parameters of interest as designated by the trial team, and a score of less than 1.0 for less favorable jurors.

In an embodiment, the analysis engine may calculate the juror rankings. The juror rankings may be a list of the potential jurors sorted according to the juror indexes with higher value indexes, and therefore more favorable jurors, at the top of the list and lower indexes, and therefore less desirable jurors, at the bottom of the list. However, this is not the only ranking of jurors that is possible to order and deliver to the trial attorney or trial team. A ranking of jurors having the least desirable jurors presented first is equally possible as an output of the analysis engine. Other rankings and orders may also be available to meet the requests of trial attorneys and trial team members as well.

In an embodiment, the analysis engine system may be composed of a plurality of the software modules herein disclosed. One or more software modules may retrieve data, or other information such as metadata, from the juror information database to acquire information including but not limited to demographic data, parameters, and lists of network destinations. The software modules may store information to the juror information database to save information including but not limited to results of calculations performed by the analysis engine and information provided via the user interface. The system may query the public records network destinations and the social media network destinations to collect information defined by the list of public records network destinations and the list of social media network destinations. The system may communicate with the user interface to present results. The system may also be directed to perform actions based upon input received from the user interface. As non-limiting examples, input received from the user interface may direct the system to mark the potential juror as seated or dismissed, may change parameters stored as the trial specific information, or recalculate scores and rankings.

In an embodiment, the invention herein disclosed may also provide methods for performing the vetting of potential jurors. The vetting disclosed in a non-limiting example of a vetting method may comprise the steps of initializing the database, acquiring a list of potential jurors, acquiring a list of litigants, acquiring a list of witnesses, acquiring a list of court officials, acquiring juror questionnaire responses, updating analysis parameters, updating weighting factors, collecting public records, collecting social media records, computing demographic scores, computing social media scores, computing final scores, computing indexes, computing rankings, presenting results, making a decision to challenge, making a decision to question, questioning a jury panel, inputting individual juror responses, issuing challenges, and recording juror dispositions.

In an embodiment, initializing the database may include functions and process steps to create and initialize database tables and/or to enter records specific to the current trial. As non-limiting examples, records specific to the current trial may comprise a name or other identifier for the case, a calendar of events, an indication of whether the case is criminal or civil, an indication of whether the trial team is representing the plaintiffs or defendants, an indication of whether the case involves the death penalty, an identification of the jurisdiction, and a count of the number of peremptory challenges allowed, among other information requested and/or required.

Acquiring a list of potential jurors may consist of receiving a list of the potential jurors and entering the information disclosed by the list into the juror information database as records to be included in the juror information records.

Acquiring a list of litigants may consist of receiving the list of litigants and entering the information disclosed by the list into the juror information database as subrecords of the trial specific information.

Acquiring a list of witnesses may consist of receiving the list of witnesses and entering the information disclosed by the list into the juror information database as subrecords of the trial specific information.

Acquiring a list of court officials may consist of receiving the list of court officials and entering the information disclosed by the list into the juror information database as subrecords of the trial specific information.

Acquiring juror questionnaire responses may consist of receiving a set of completed juror questionnaires or a compilation of the responses given on the questionnaires and entering the information disclosed by the questionnaires into the juror information database as information to be included in the juror information records.

Updating analysis parameters may consist of creating, deleting, or modifying the parameters associated with individual facts of interest during the analysis as stored in the juror information database as the demographic parameters, the social media parameters, and/or the panel response parameters. In a non-limiting example, updating analysis parameters may consist of creating a new parameter, giving the new parameter a name, describing where the value of the new parameter can be acquired, describing possible values or ranges of values that the new parameter may take on, and describing the score that should be given for each value or range of value of the parameter during the scoring phase. The description of where the value of the new parameter can be acquired may include the network address of a network destination, a specific query to be made to that network destination, and a description of how to find the desired value in the response from the network destination.

Updating weighting factors may consist of creating, deleting, or modifying the demographic weighting factors, the social media weighting factor, the panel analysis category weighting factor, the demographic component weight, the social media component weight, and the panel analysis component weight as stored in the juror information database as a subrecord of the trial specific information.

Collecting public records may consist of sending one or more queries to one or more public of the public records network destinations, interpreting the responses from the public records network destinations, and making the acquired parameters available to the analysis engine for scoring. The information collected from the public records network destinations may be used to update or supplement the demographic information stored in the juror information database as an update to the juror information record.

Collecting social media records may consist of sending one or more queries to one or more of the social media network destinations, interpreting the responses from the social media network destinations, and making the acquired parameters available to the analysis engine for scoring. The information collected from the social media network destinations may be used to update or supplement the juror information record.

Computing demographic scores may consist of determining the demographic parameter score associated with one of the potential jurors for one parameter, multiplying the demographic parameter score by the demographic weighting factor for that parameter to form the weighted demographic parameter score, repeating the determination and multiplication for each of the demographic parameters associated with the potential juror, summing all of the weighted demographic parameter scores to compute the demographic component score for the potential juror, multiplying the demographic component score by the demographic component weight to compute the weighted demographic component score for the potential juror, and then repeating the computation of the weighted demographic component score for all of the potential jurors. The weighted demographic component scores thus computed for all of the potential jurors are stored in the juror information database as the weighted demographic component scores.

Computing social media scores may consist of determining the social media parameter score associated with one of the potential jurors for one parameter, multiplying the social media parameter score by the social media weighting factor for that parameter to form the weighted social media parameter score, repeating the determination and multiplication for each of the social media parameters associated with the potential juror, summing all of the weighted social media parameter scores to compute the social media component score for the potential juror, multiplying the social media component score by the social media component weight to compute the weighted social media component score for the potential juror, and then repeating the computation of the weighted social media component score for all of the potential jurors. The weighted social media component scores thus computed for all of the potential jurors are stored in the juror information database as the weighted social media component scores.

Computing final scores may consist of computing the juror final scores by computing panel analysis scores and summing the weighted demographic component scores, the weighted social media component scores, and the weighted panel analysis component scores for each of the potential jurors. The juror final scores are stored in the juror information database. Computing final scores may further mean determining whether connections exist between individuals.

Computing indexes may consist of computing the juror index for each of the potential jurors. The juror index is computed for the potential juror by dividing the juror final score for a specific one of the potential jurors by the average juror score to determine the juror index for the potential juror. The average juror score is computed by summing the juror final scores for all of the potential jurors and dividing that sum by the count of the potential jurors. The juror indexes are stored in the juror information database.

Computing rankings may consist of sorting the list of potential juror names in order of the juror index associated with each of the potential jurors from largest to smallest. The potential jurors with the largest value of the juror index are deemed to be the best candidates for the jury.

Presenting results may consist of showing the juror final scores, the juror indexes, the juror rankings or combinations thereof on the user interface. Presenting results may further mean showing the one or more messages resulting from analysis of information in the juror information database by the analysis engine. In a non-limiting example, the one or more messages may document a connection found to exist between the potential juror and a person or entity appearing on the list of litigants, the list of witnesses, or the list of court officials.

Making a decision to challenge may consist of determining whether a criterion exists for challenging the potential juror.

Making a decision to question may consist of determining whether a question should be asked to one or more of the potential jurors.

Questioning a jury panel may consist of selecting one or more questions from the list of panel questions, asking the one or more questions to one or more of the potential jurors, and noting the response given by all of the potential jurors who respond to the question. Questioning a jury panel may further mean noting a question asked by opposing counsel and noting the response given by all of the potential jurors who respond to the question.

Inputting individual juror responses may consist of entering into the user interface indications of which questions were asked, which of the potential jurors responded, and what response each of the potential jurors gave. The indications of responses entered into the user interface may be the actual response value given by the potential juror which the analysis engine will then map into the panel question score or the indications of responses entered into the user interface may be the panel question score as determined by a member of the trial team. Inputting individual juror responses is performed immediately after a question is asked so that the analysis engine may update scores, indexes, and rankings in real time.

Issuing challenges may consist of issuing challenges for cause or peremptory challenges based upon statements made by the potential juror, scores, indexes, rankings or messages presented by the analysis engine.

Recording juror dispositions may consist of entering into the user interface indications that any of the potential jurors have been seated as a juror or have been dismissed for any reason. In some embodiments, the analysis engine may eliminate the potential jurors who have been dismissed from further consideration and may compute scores, indexes, and rankings based upon a smaller pool of the potential jurors.

Computing panel analysis scores may consist of determining the panel analysis category score associated with one of the potential jurors for one category, multiplying the panel analysis category score by the panel analysis category weighting factor for that category to form the weighted panel analysis score, repeating the determination and multiplication for each of the panel analysis categories associated with the potential juror, summing all of the weighted panel analysis scores to compute the panel analysis component score for the potential juror, multiplying the panel analysis component score by the panel analysis component weight to compute the weighted panel analysis component score for the potential juror, and repeating the computation of the weighted panel analysis component score for all of the potential jurors. The weighted panel analysis component scores thus computed for all of the potential jurors are stored in the juror information database as the weighted panel analysis component scores.

Determining whether connections exist between individuals may consist of analyzing information available from any source, including but not limited to demographic information, information obtained from the public records network destinations, information obtained from the social media network destinations, and information obtained from juror questionnaires to determine whether connections exist between any of the potential jurors and any person or entity listed on the list of litigants, the list of witnesses, or the list of court officials. Non-limiting examples of connections may include familial relationships, social relationships, employment for or with another individual, attending the same religious institution, living in the same neighborhood, and belonging to the same clubs or teams.

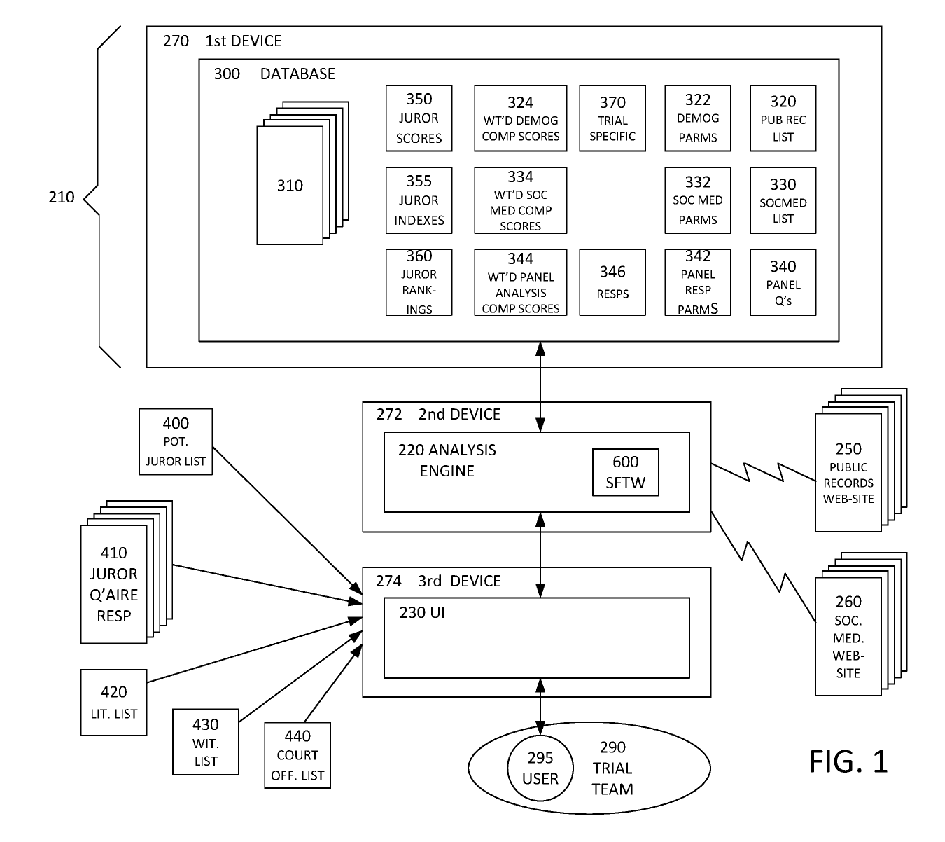

Turning now to FIG. 1, the figure is a block diagram of an embodiment of the system disclosed. The first computing device 270, the second computing device 272 and the third computing device 274 represent hardware platforms that may be used to host the juror information database 300, the analysis engine 220 and associated analysis engine system, and the user interface 230 respectively.

In some embodiments, the juror information database 300 and the analysis engine 220 may be hosted on the same hardware platform or the juror information database 300, the analysis engine 220 and the user interface 230 may be hosted on the same platform. The user interface 230 will generally be used inside of the courtroom while the juror information database 300 and the analysis engine 220 may be hosted at a location outside of the courtroom.

The public records network destinations 250 and the social media network destinations 260 represent network destinations that are sources of information for the invention 100. The trial team 290 represents the legal team that is using the invention 100 with at least one member of the trial team 290 designated as the user 295 who will interact with the user interface 230. The list of potential juror names 400, the plurality of juror questionnaires 410, the list of litigants 420, the list of witnesses 430, and the list of court officials 440 represent additional sources of information which are more closely tied to the trial and which are provided to the trial team 290 by the court system or are created by the trial team 290.

The juror information records 310, the list of public records network destinations 320, the list of social media network destinations 330, the list of panel questions 340, the demographic parameters 322, the social media parameters 332, the panel response parameters 342, and the trial specific information 370 represent information which is stored within the juror information database 300 and which is prepared by the trial team 290 in advance of the voir dire proceeding. The panel question responses 346, the weighted demographic component scores 324, the weighted social media component scores 334, the weighted panel analysis component scores 344, the juror final score 350, the juror index 355, and the juror ranking 360 represent information which is stored within the juror information database 300 and which is captured or computed during the voir dire proceeding. Specific details about this information has been presented elsewhere in this disclosure. The software modules 600 implement the functions of the analysis engine 220 and have also been described elsewhere in this disclosure.

FIG. 1 attempts to illustrate the types of information that may be stored within the juror information database 300 but should not be construed as dictating a particular architecture or table structure for the juror information database 300.

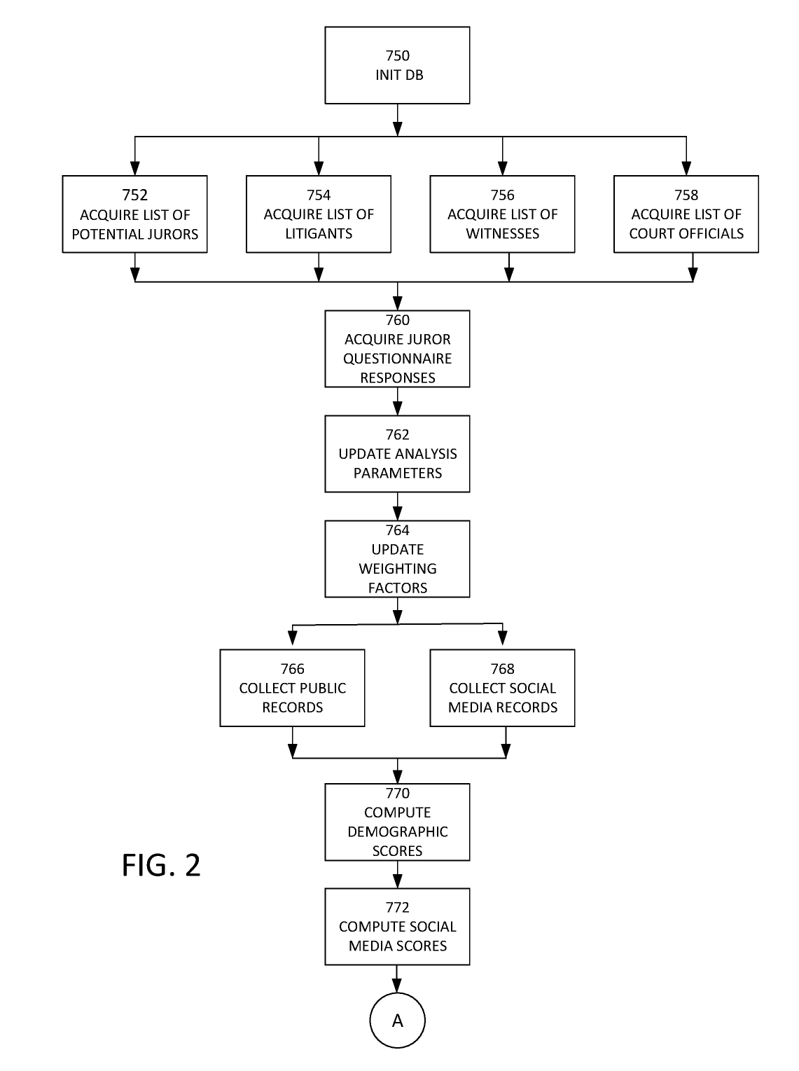

Turning now to FIG. 2, the figure is a flow diagram of steps in the methodology which happen prior to the voir dire proceeding. These steps are described in more detail elsewhere in the disclosure; an overview is provided here. The flow begins at block 750 representing initialization of the database. From block 750, blocks 752, 754, 756, and 758 are completed next in any order including being completed in parallel as shown. These blocks represent acquiring, or creating, and entering into the database lists of trail participants. Block 760 represents acquiring and entering questionnaire forms that each potential juror has completed. Block 762 represents creating, deleting, or modifying the database entries that determine which public records and what social media content the analysis engine 220 should collect and analyze. Block 764 represent creating, deleting, or modifying the database entries that determine the weighting factors applied during scoring. Blocks 766 and 768 represent that actions of the analysis engine 220 to visit the public records network destinations 250 and the social media network destinations 260 and to collect the information that has been specified by the demographic parameters 322 and the social media parameters 332. Block 770 represents the actions of the analysis engine 220 to score the demographic parameters 322 as described elsewhere in this disclosure. Block 772 represents the actions of the analysis engine 220 to score the social media parameters 332 as described elsewhere in this disclosure. As the conclusion of block 772, the trial team 290 is ready to begin the voir dire proceeding.

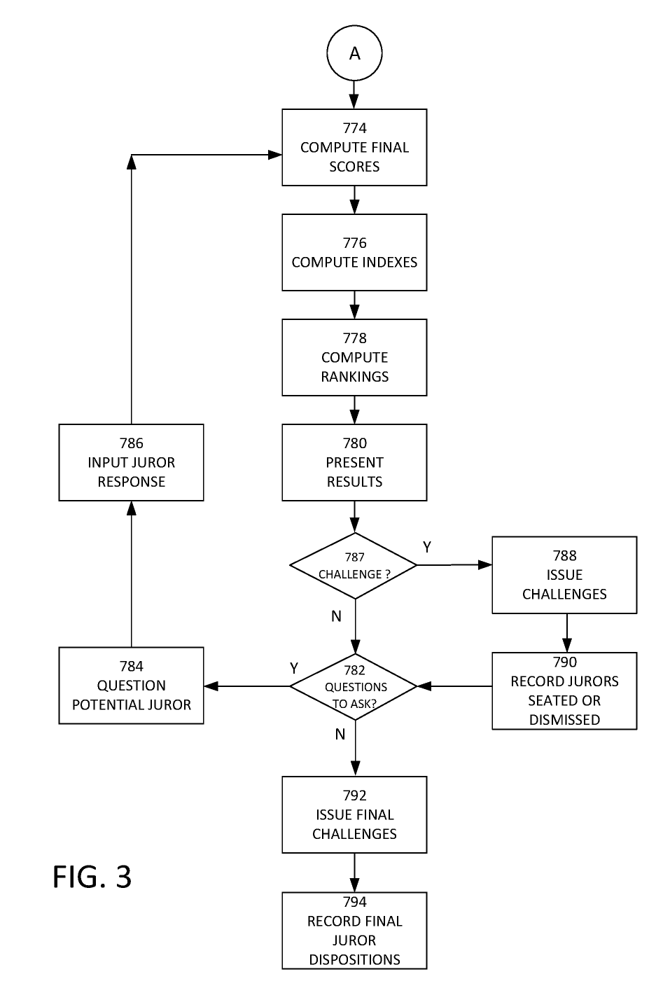

Turning now to FIG. 3, the figure is a flow diagram of steps that form the voir dire proceeding. This diagram presents an overview of the proceeding, with a more detailed discussion provided elsewhere in this disclosure. Block 774 proceeds on the assumption that the pre-voir dire proceeding steps shown in FIG. 2 have been completed. Block 774 represents the computation of the final scores for each of the potential jurors as described previously. During the first pass through block 774, no voir dire questioning has been completed so the final scores are based solely on demographics and social media information. Block 776 represents the calculation of an index for each of the potential jurors as described previously. Block 778 represents the calculation of a pre-defined sorted list of the potential jurors. Block 780 represents presenting the final scores, indexes, and rankings of the potential jurors to the trial team 290.

In an embodiment, the information presented to the trial team 290 may also include the one or more messages pointing out significant results of the analysis. As a non-limiting example, the one or more messages may point out a connection discovered between one of the potential jurors and a participant in the trail, such as a litigant or opposing counsel. Block 787 discloses that the trial team 290 may make a decision to challenge a juror based upon results presented on the user interface 230 or for reasons unrelated to the use of the invention 100. If the trial team 290 decides to challenge the juror, then in block 788 the challenge is issued and in block 790 the juror information database 300 is updated to reflect that the juror has been removed from the plurality of potential jurors. In this embodiment, if opposing counsel challenges a juror an entry will also be made into the juror information database 300 to reflect the removal of that juror from the panel. After the challenge, or if no challenge is made, block 782 represents the trial team 290 deciding whether or not they wish to ask more questions. If the trial team 290 wishes to ask more questions, in block 784 one or more of the potential jurors are asked a question and in block 786 the responses given by any of the potential jurors may be entered into the juror information database 300 via the user interface 230. Entering the panel question responses 346 prompts the analysis engine 220 to recalculate the scores, bringing the flow back to block 774. At each subsequent pass through this loop, block 780 will present new scores which reflect, in real time, the current answers provided by any of the potential jurors.

If, in block 782, the trial team 290 decides that they have no additional questions for any of the potential jurors, block 792 reflects that the trial team 290 may issue any final challenges that they have not yet issued. In this embodiment, block 794 reflects that the final disposition of seated and dismissed jurors is entered into the juror information database 300.

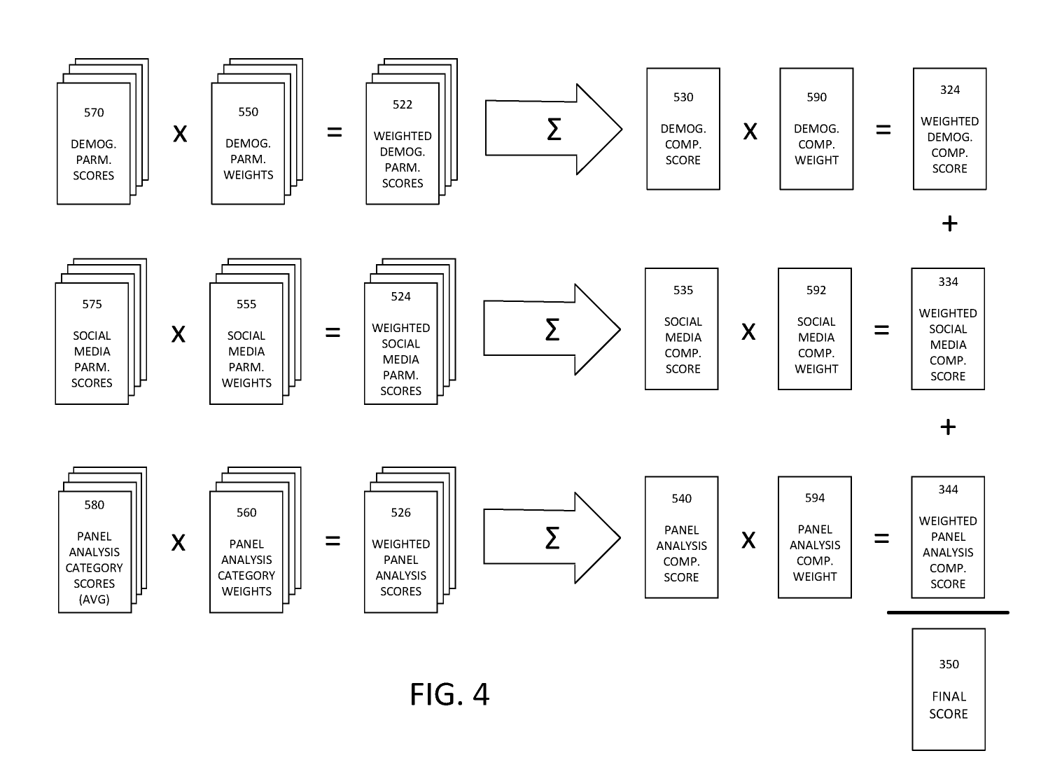

Turning now to FIG. 4, this figure illustrates the process of computing a final score for one of the potential jurors. The top, horizontal row of boxes represents the demographic score which includes information obtained from the plurality of juror questionnaires 410 and from the public records network destinations 250. The middle, horizontal row of boxes represents the social media score which includes information obtained from the social media network destinations 260. The bottom, horizontal row of boxes represents the panel analysis score which includes information obtained during voir dire questioning.

Each of the demographic parameter scores 570 each represent a score for one of the demographic parameters 322 associated with the potential juror. As described in detail elsewhere in this disclosure, the demographic parameter scores 570 are multiplied by the demographic weighting factors 550 to produce the weighted demographic parameter scores 522 which are then summed to obtain the demographic component score 530 for the potential juror. Likewise, the social media parameter scores 575 are multiplied by the social media weighting factors 555 to produce the weighted social media parameter scores 524 which are then summed to obtain the social media component score 535 for the potential juror and the panel analysis category scores 580 are multiplied by the panel analysis category weighting factors 560 to produce the weighted panel analysis scores 526 which are then summed to obtain the panel analysis component score 540 for the potential juror.

The demographic component score 530 is multiplied by the demographic component weight 590 to produce one of the weighted demographic component scores 324, the social media component score 535 is multiplied by the social media component weight 592 to produce one of the weighted social media component scores 334, and the panel analysis component score 540 is multiplied by the panel analysis component weight 594 to produce one of the weighted panel analysis component scores 344. The juror final score 350 is computed by summing one of the weighted demographic component scores 324, one of the weighted social media component scores 334 and one of the weighted panel analysis component scores 344 which are associated with the potential juror.

While certain illustrative embodiments have been described, it is evident that many alternatives, modifications, permutations and variations will become apparent to those skilled in the art in light of the foregoing description.

What is claimed is:

1. A system for juror selection, comprising:
a processor, an electronic file storage element in data communication with said processor, an analysis engine operating within said processor, and a user interface presented to a user by said processor;
collecting data elements providing information about a trial and about jurors within a jury pool assigned to said trial and input through said user interface and stored within said electronic file storage element;
creating and storing within said electronic file storage element a set of weighting factors for said collected data elements;
calculating a juror score for each of said jurors within a jury pool utilizing said collected data elements and said weighting factors and saving said juror scores in the electronic file storage element;
providing a set of calculated juror scores to a user, where said set of calculated juror scores includes each juror in the jury pool;
collecting responses to questions asked of one or more jurors by a user during the process of voir dire;
updating said data elements and said weighting factors in real time based upon said responses from the one or more jurors;
recalculating one or more calculated juror scores in real time;
providing said one or more recalculated juror scores in real time to a user.

2. The system of claim 1, further comprising collecting information from public data sources.

3. The system of claim 1, where said information about a trial comprises at least witness list, litigant, court official list information.

4. The system of claim 1, where said information about jurors within a jury pool assigned to said trial comprises at least juror demographic information, juror social media information, juror questionnaire information, and juror panel responses to questions posed by a user during juror selection.

5. The system of claim 1, where a juror score consists of data elements that comprise at least juror demographic information and a weighting factor for said juror demographic information, juror social media information and a weighting factor for said juror social media information, and juror panel information and a weighting factor for said juror panel information.

6. The system of claim 5, where the juror score is calculated in real time and updated as information becomes available in response to questions asked of any juror in said jury pool during the voir dire process.

7. The system of claim 5, where one or more juror scores are provided to a user on demand by transmitting said juror scores to a computer display, mobile device, smart phone, or any other display device having a network connection.

8. The system of claim 1, further comprising a juror index and a juror ranking calculated by ordering said calculated juror scores according to a user expressed order.

9. The system of claim 8, further comprising presenting a list of jurors empaneled onto a jury to the user where said list of jurors is ordered in compliance with a user expressed order.

10. The system of claim 1, further comprising discovering familial, social, business, or membership connections that exist between potential jurors and participants in the litigation and presenting this information to a user.

11. A process for juror selection, comprising:
collecting data elements providing information about a trial and about jurors within a jury pool assigned to said trial and input through said user interface and stored within said electronic file storage element;
creating and storing within said electronic file storage element a set of weighting factors for said collected data elements;
calculating a juror score for each of said jurors within a jury pool utilizing said collected data elements and said weighting factors and saving said juror scores in the electronic file storage element;
providing a set of calculated juror scores to a user, where said set of calculated juror scores includes each juror in the jury pool;
collecting responses to questions asked of one or more jurors by a user during the process of voir dire;
updating said data elements and said weighting factors in real time based upon said responses from the one or more jurors;
recalculating one or more calculated juror scores in real time;
providing said one or more recalculated juror scores to a user during voir dire;
presenting said user with a recommendation to challenge a particular juror based at least in part on the juror score and whether the juror score exceeds a pre-set threshold.

12. The system of claim 11, further comprising collecting information from public data sources.

13. The system of claim 11, where said information about a trial comprises at least witness list, litigant, court official list information.

14. The system of claim 11, where said information about jurors within a jury pool assigned to said trial comprises at least juror demographic information, juror social media information, juror questionnaire information, and juror panel responses to questions posed by a user during juror selection.

15. The system of claim 11, where a juror score consists of data elements that comprise at least juror demographic information and a weighting factor for said juror demographic information, juror social media information and a weighting factor for said juror social media information, and juror panel information and a weighting factor for said juror panel information.

16. The system of claim 15, where the juror score is calculated in real time and updated as information becomes available in response to questions asked of any juror in said jury pool during the voir dire process.

17. The system of claim 15 where one or more juror scores are provided to a user on demand by transmitting said juror scores to a computer display, mobile device, smart phone, or any other display device having a network connection.

18. The system of claim 11, further comprising a juror index and a juror ranking calculated by ordering said calculated juror scores according to a user expressed order.

19. The system of claim 18, further comprising presenting a list of jurors empaneled onto a jury to the user where said list of jurors is ordered in compliance with a user expressed order.

20. The system of claim 11, further comprising discovering familial, social, business, or membership connections that exist between potential jurors and participants in the litigation and presenting this information to a user.
